(19) United States
(12) Patent Application Publication
(10) Pub. No.: US 2022/0088878 A1
(43) Pub. Date: Mar. 24, 2022

(54) ADAPTING MANUFACTURING SIMULATION

(71) Applicant: Hewlett-Packard Development Company, L.P., Spring, TX (US)

(72) Inventors: Jun Zeng, Palo Alto, CA (US); Carlos Alberto Lopez Collier de la Marliere, Guadalajara (MX); He Luan, Palo Alto, CA (US)

(73) Assignee: Hewlett-Packard Development Company, L.P., Spring, TX (US)

(21) Appl. No.: 17/415,188

(22) PCT Filed: Jun. 11, 2019
(86) PCT No.: PCT/US2019/036505

§ 371 Date: Jun. 17, 2021

(51) Int. Cl. B29C 64/393; B33Y 50/02; G06F 30/27; B22F 12/90; B22F 10/85

(52) U.S. Cl. CPC B29C 64/393; B33Y 50/02; B22F 10/85; B22F 12/90; G06F 30/27

(57) ABSTRACT

Examples of methods for adapting a simulation of three-dimensional (3D) manufacturing are described herein. In some examples, a method includes determining, using a machine learning model, a predicted thermal image based on a thermal imaging stream of 3D manufacturing. In some examples, a method includes adapting a simulation of the 3D manufacturing based on the predicted thermal image.

### BACKGROUND

Three-dimensional (3D) solid parts may be produced from a digital model using additive manufacturing. Additive manufacturing may be used in rapid prototyping, mold generation, mold master generation, and short-run manufacturing. Additive manufacturing involves the application of successive layers of build material. This is unlike traditional machining processes that often remove material to create the final part. In some additive manufacturing techniques, the build material may be cured or fused.

### BRIEF DESCRIPTION OF THE DRAWINGS

FIG. 1 is a simplified perspective view of an example of a 3D printing device that may be used in an example of adapting manufacturing simulation;

FIG. 2 is a block diagram illustrating examples of functions that may be implemented for adapting manufacturing simulation;

FIG. 3 is a block diagram of an example of an apparatus that may be used in adapting manufacturing simulation;

FIG. 4 is a flow diagram illustrating an example of a method 400 for adapting manufacturing simulation; and

FIG. 5 is a simplified perspective view of an example of visualizations of simulation results in accordance with some examples of the techniques described herein.

### DETAILED DESCRIPTION

Additive manufacturing may be used to manufacture three-dimensional (3D) objects. 3D printing is an example of additive manufacturing. Some examples of 3D printing may selectively deposit agents (e.g., droplets) at a pixel level to enable control over voxel-level energy deposition. For instance, thermal energy may be projected over material in a build area, where a phase change and solidification in the material may occur depending on the voxels where the agents are deposited.

A voxel is a representation of a location in a 3D space. For example, a voxel may represent a component of a 3D space. For instance, a voxel may represent a volume that is a subset of the 3D space. In some examples, voxels may be arranged on a 3D grid. For instance, a voxel may be rectangular or cubic in shape. Examples of a voxel size dimension may include 25.4 millimeters (mm)/150≈170 microns for 150 dots per inch (dpi), 490 microns for 50 dpi, 2 mm, etc. The term “voxel level” and variations thereof may refer to a resolution, scale, or density corresponding to voxel size. In some examples, the term “voxel” and variations thereof may refer to a “thermal voxel.” In some examples, the size of a thermal voxel may be defined as a minimum that is thermally meaningful (e.g., greater than or equal to 42 microns or 600 dots per inch (dpi)). A set of voxels may be utilized to represent a build volume. A build volume is a volume in which an object or objects may be manufactured. The term “voxel level” and variations thereof may refer to a resolution, scale, or density corresponding to voxel size.

In some examples of 3D manufacturing (e.g., multi-jet fusion (MJF)), each voxel in the build volume may undergo a thermal procedure (approximately 15 hours of build time (e.g., time for layer-by-layer printing) and approximately 35 hours of additional cooling). The thermal procedure of voxels that include an object may affect the manufacturing quality (e.g., functional quality) of the object.

Thermal sensing may provide a small amount of thermal information (e.g., a small amount of spatial thermal information of the build volume and/or a small amount of temporal thermal information over about 50 hours of build and cooling). For example, a thermal sensor (e.g., camera, imager, etc.) may capture about 10 seconds of a thermal voxel's 50-hour procedure when the voxel is exposed as part of a fusing layer, thereby resulting in a lack of temporal coverage. Thermal sensors at the walls and bottom of the build volume may report transient temperatures of a few selected spots, thereby resulting in a lack of spatial coverage.

Some theory-based simulation approaches (e.g., simulations based on thermodynamics laws) may provide additional spatial and temporal information for the thermal procedure (e.g., manufacturing). However, some types of simulations may not capture current (e.g., up-to-the-moment) reality and/or may not account for variation(s) in printer operation (e.g., environmental variation, printer drift, printer variation, and/or printer functioning). For example, a printer may behave differently in different environments (due to variations in humidity, for instance). Printer drifts may occur, where performance gradually changes with time, for instance. Different printers (of the same model or of different models) may behave slightly differently. Different printer functioning (e.g., settings, powder refresh rates, etc.) may cause a printer behavior change. Some types of theory-based simulations fail to capture these variations in printer operation. A simulation of manufacturing is a procedure to model actual manufacturing. For example, simulation may be an approach to provide a prediction of manufacturing. Machine learning may be another approach to provide a prediction of manufacturing. Some examples of the techniques described herein may combine a simulation approach and a machine learning approach to provide a prediction or predictions. For example, machine learning may provide predicted thermal image(s), which may be utilized to improve simulation.

In some examples of the techniques described herein, a thermal imaging stream obtained by a thermal sensor or sensors may be utilized to correct a simulation and/or provide additional (e.g., complete) spatial and temporal coverage and reflect current (e.g., up-to-the-moment) ground truth for 3D manufacturing. For example, thermal imaging may be utilized to correct a simulation of MJF manufacturing. A thermal image is a set of values representing temperature or thermal energy over an area or volume. For instance, a thermal image may be a two-dimensional array of temperatures for a layer in a build volume. In some examples, machine learning (e.g., deep learning, neural network(s), etc.) may be utilized to predict a thermal image or images for a future layer or layers of build material. A future layer is a layer that is not yet completed. A layer in which build material may be fused may be referred to as a fusing layer. In some examples, predicted thermal image(s) for future layer(s) may be predicted based on thermal image(s) (e.g., videos) of previous layer(s) that are captured by a thermal sensor embedded in a printer. Predicted thermal images may indicate transient thermal behavior for a layer or layers. In some examples, a layer height may be approximately 80 micro meters (μm), with a horizontal (e.g., x, y) resolution of 50 μm. Other resolutions may be utilized in other examples. In some examples, a layer print time may be approximately 6 seconds. Other layer print times may be utilized in other examples.

In some examples of the techniques described herein, 3D manufacturing simulation may be adapted based on the thermal image(s) predicted with machine learning. For example, a predicted thermal image may be utilized for a boundary condition in the simulation. A boundary condition is a condition to be satisfied at a boundary of a region. For instance, a boundary condition may dictate the temperature(s) to be satisfied by the simulation at a boundary of a region when simulating the thermal behavior of the region (e.g., area or volume). For example, a predicted thermal image may be utilized as a temperature state for a boundary condition of a top layer (e.g., layer K) for all thermal voxels at a fusing layer.

In some examples of the techniques described herein, thermal image data may be adjusted to increase simulation stability. For instance, a numerical controller can be implemented at each fusing layer voxel to enhance numerical stability.

While plastics (e.g., polymers) may be utilized as a way to illustrate some of the approaches described herein, the techniques described herein may be utilized in various examples of additive manufacturing. For instance, some examples may be utilized for plastics, polymers, semi-crystalline materials, metals, etc. Some additive manufacturing techniques may be powder-based and driven by powder fusion. Some examples of the approaches described herein may be applied to area-based powder bed fusion-based additive manufacturing, such as Stereolithography (SLA), Multi-Jet Fusion (MJF), Metal Jet Fusion, Selective Laser Melting (SLM), Selective Laser Sintering (SLS), liquid resin-based printing, etc. Some examples of the approaches described herein may be applied to additive manufacturing where agents carried by droplets are utilized for voxel-level thermal modulation.

In some examples, “powder” may indicate or correspond to particles insulated with air pockets. A powder's ability to transmit heat is limited, relying on limited touching surfaces among particles. An “object” may indicate or correspond to a location (e.g., area, space, etc.) where particles are sintered, melted, or solidified that is filled primarily with the material itself without air bubbles or with small air bubbles. For example, an object may be formed from sintered or melted powder. An object's ability to transmit heat may be close to that of the bulk material itself.

In some examples, a predicted thermal image may be a thermal image that is calculated using a machine learning model. For instance, the neural network or networks may utilize a contone map or maps (e.g., voxel-level machine instructions that dictate the placement, quantity, and/or timing of an agent or agents in a build area) and/or a thermal image or images to predict a thermal image.

A captured thermal image is a thermal image that is sensed or captured with a sensor. Sensors for capturing thermal images may be limited in resolution. For example, a built-in sensor in an additive manufacturing device may provide relatively low resolution (e.g., 31×30 pixels, 80×60 pixels, 90×90 pixels, etc.) for online (e.g., run-time) thermal imaging. It may be beneficial to utilize a low-resolution thermal image sensor built-in to an additive manufacturing device due to the expense, size, and/or other considerations that may keep a high-resolution sensor from being utilized.

Low resolution thermal imaging may be inadequate to support voxel level thermal prediction in some approaches. Some examples of the techniques described herein may include a deep neural network based approach that can achieve voxel-level thermal prediction with low-resolution thermal sensing and a contone map or maps as input. In some examples, thermal image prediction that is greater than the resolution of thermal sensing can be achieved (e.g., from 31×30 pixels, 80×60 pixels, or 90×90 pixels to 640×480 pixels). Missing details may be inferred from additional information (e.g., contone maps). Some examples may enable online in-situ voxel-level thermal image prediction and/or online closed-loop feedback control.

The term “low resolution” and variations thereof may refer to a resolution, scale, or density that is less than that of a voxel level. For example, a low resolution is less than a voxel-level resolution. Low-resolution thermal imaging may depend on the pixel resolution in a manufacturing device (e.g., machine, printer, etc.). For example, pixel size in low resolution thermal imaging may range from 11 mm to 37 mm. While an example of low-resolution size is given, other low-resolution sizes may be utilized. As used herein, the term “high resolution” and variations thereof may denote a resolution that is greater than a low resolution.

Throughout the drawings, identical reference numbers may designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

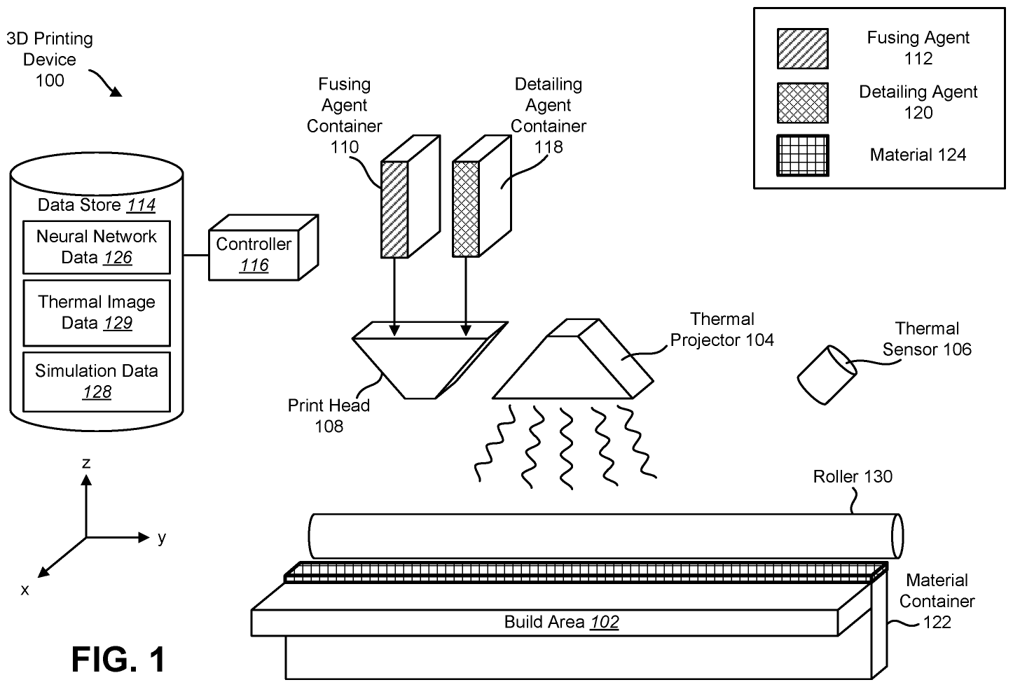

FIG. 1 is a simplified perspective view of an example of a 3D printing device 100 that may be used in an example of adapting manufacturing simulation. The 3D printing device 100 may include a controller 116, a data store 114, a build area 102, a print head 108, a fusing agent container 110, a detailing agent container 118, a roller 130, a material container 122, a thermal projector 104, and/or a thermal sensor 106. The example of a 3D printing device 100 in FIG. 1 may include additional components that are not shown, and some of the components described may be removed from the 3D printing device 100 and/or modified without departing from the scope of the 3D printing device 100 in this disclosure. The components of the 3D printing device 100 may not be drawn to scale, and thus, may have a size and/or configuration different than what is shown.

In the example of FIG. 1, the 3D printing device 100 includes a fusing agent container 110, fusing agent 112, a detailing agent container 118, detailing agent 120, a material container 122, and material 124. In other examples, the 3D printing device 100 may include more or fewer containers, agents, hoppers, and/or materials. The material container 122 is a container that stores material 124 that may be applied (e.g., spread) onto the build area 102 by the roller 130 for 3D printing. The fusing agent container 110 is a container that stores a fusing agent 112. The fusing agent 112 is a substance (e.g., liquid, powder, etc.) that controls intake thermal intensity. For example, the fusing agent 112 may be selectively applied to cause applied material 124 to change phase with heat applied from the thermal projector 104 and/or to fuse with another layer of material 124. For instance, areas of material 124 where the fusing agent 112 has been applied may eventually solidify into the object(s) being printed. The detailing agent 120 is a substance (e.g., liquid, powder, etc.) that controls outtake thermal intensity. For example, the detailing agent 120 may be selectively applied to detail edges of the object(s) being printed.

The build area 102 is an area (e.g., surface) on which additive manufacturing may be performed. In some configurations, the build area 102 may be the base of a “build volume,” which may include a volume above the base. As used herein, the term “build area” may refer to the base of a build volume and/or another portion (e.g., another plane or planes above the base) of the build volume.

The roller 130 is a device for applying material 124 to the build area 102. In order to print a 3D object or objects, the roller 130 may successively apply (e.g., spread) material 124 (e.g., a powder) and the print head 108 may successively apply and/or deliver (e.g., print) fusing agent 112 and/or detailing agent 120. The thermal projector 104 is a device that delivers energy (e.g., thermal energy, heat, etc.) to the material 124, fusing agent 112, and/or detailing agent 120 in the build area 102. For example, fusing agent 112 may be applied on a material 124 layer where particles (of the material 124) are meant to fuse together. The detailing agent 120 may be applied to modify fusing and create fine detail and/or smooth surfaces. The areas exposed to energy (e.g., thermal energy from the thermal projector 104) and reactions between the agents (e.g., fusing agent 112 and detailing agent 120) and the material 124 may cause the material 124 to selectively fuse together to form the object(s).

The print head 108 is a device to apply a substance or substances (e.g., fusing agent 112 and/or detailing agent 120). The print head 108 may be, for instance, a thermal inkjet print head, a piezoelectric print head, etc. The print head 108 may include a nozzle or nozzles (not shown) through which the fusing agent 112 and/or detailing agent 120 are extruded. In some examples, the print head 108 may span a dimension of the build area 102. Although a single print head 108 is depicted, multiple print heads 108 may be used that span a dimension of the build area 102. Additionally, a print head or heads 108 may be positioned in a print bar or bars. The print head 108 may be attached to a carriage (not shown in FIG. 1). The carriage may move the print head 108 over the build area 102 in a dimension or dimensions.

The material 124 is a substance (e.g., powder) for manufacturing objects. The material 124 may be moved (e.g., scooped, lifted, and/or extruded, etc.) from the material container 122, and the roller 130 may apply (e.g., spread) the material 124 onto the build area 102 (on top of a current layer, for instance). In some examples, the roller 130 may span a dimension of the build area 102 (e.g., the same dimension as the print head 108 or a different dimension than the print head 108). Although a roller 130 is depicted, other means may be utilized to apply the material 124 to the build area 102. In some examples, the roller 130 may be attached to a carriage (not shown in FIG. 1). The carriage may move the roller 130 over the build area 102 in a dimension or dimensions. In some implementations, multiple material containers 122 may be utilized. For example, two material containers 122 may be implemented on opposite sides of the build area 102, which may allow material 124 to be spread by the roller 130 in two directions.

In some examples, the thermal projector 104 may span a dimension of the build area 102. Although one thermal projector 104 is depicted, multiple thermal projectors 104 may be used that span a dimension of the build area 102. Additionally, a thermal projector or projectors 104 may be positioned in a print bar or bars. The thermal projector 104 may be attached to a carriage (not shown in FIG. 1). The carriage may move the thermal projector 104 over the build area 102 in a dimension or dimensions.

In some examples, each of the print head 108, roller 130, and thermal projector 104 may be housed separately and/or may move independently. In some examples, two or more of the print head 108, roller 130, and thermal projector 104 may be housed together and/or may move together. In one example, the print head 108 and the thermal projector 104 may be housed in a print bar spanning one dimension of the build area 102, while the roller 130 may be housed in a carriage spanning another dimension of the build area 102. For instance, the roller 130 may apply a layer of material 124 in a pass over the build area 102, which may be followed by a pass or passes of the print head 108 and thermal projector 104 over the build area 102.

The controller 116 is a computing device, a semiconductor-based microprocessor, a Central Processing Unit (CPU), Graphics Processing Unit (GPU), Field-Programmable Gate Array (FPGA), an application-specific integrated circuit (ASIC), and/or other hardware device. The controller 116 may be connected to other components of the 3D printing device 100 via communication lines (not shown).

The controller 116 may control actuators (not shown) to control operations of the components of the 3D printing device 100. For example, the controller 116 may control an actuator or actuators that control movement of the print head 108 (along the x-, y-, and/or z-axes), actuator or actuators that control movement of the roller 130 (along the x-, y-, and/or z-axes), and/or actuator or actuators that control movement of the thermal projector 104 (along the x-, y-, and/or z-axes). The controller 116 may also control the actuator or actuators that control the amounts (e.g., proportions) of fusing agent 112 and/or detailing agent 120 to be deposited by the print head 108 from the fusing agent container 110 and/or detailing agent container 118. In some examples, the controller 116 may control an actuator or actuators that raise and lower build area 102 along the z-axis.

The controller 116 may communicate with a data store 114. The data store 114 may include machine-readable instructions that cause the controller 116 to control the supply of material 124, to control the supply of fusing agent 112 and/or detailing agent 120 to the print head 108, to control movement of the print head 108, to control movement of the roller 130, and/or to control movement of the thermal projector 104.

In some examples, the controller 116 may control the roller 130, the print head 108, and/or the thermal projector 104 to print a 3D object or objects based on a 3D model. For instance, the controller 116 may utilize a contone map or maps that are based on the 3D model to control the print head 108. A contone map is a set of data indicating a location or locations (e.g., areas) for printing a substance (e.g., fusing agent 112 or detailing agent 120). In some examples, a contone map may include or indicate machine instructions (e.g., voxel-level machine instructions) for printing a substance. For example, a fusing agent contone map indicates coordinates and/or an amount for printing the fusing agent 112. In an example, a detailing agent contone map indicates coordinates and/or an amount for printing the detailing agent 120. In some examples, a contone map may correspond to a two-dimensional (2D) layer (e.g., 2D slice, 2D cross-section, etc.) of the 3D model. For instance, a 3D model may be processed to produce a plurality of contone maps corresponding to a plurality of layers of the 3D model. In some examples, a contone map may be expressed as a 2D grid of values, where each value may indicate whether to print an agent and/or an amount of agent at the location on the 2D grid. For instance, the location of a value in the 2D grid may correspond to a location in the build area 102 (e.g., a location (x, y) of a particular level (z) at or above the build area 102). In some examples, a contone map may be a compressed version of the aforementioned 2D grid or array (e.g., a quadtree).

The data store 114 is a machine-readable storage medium. Machine-readable storage is any electronic, magnetic, optical, or other physical storage device that stores executable instructions and/or data. A machine-readable storage medium may be, for example, Random Access Memory (RAM), an Electrically Erasable Programmable Read-Only Memory (EEPROM), a storage drive, an optical disc, and the like. A machine-readable storage medium may be encoded with executable instructions for controlling the 3D printing device 100. A computer-readable medium is an example of a machine-readable storage medium that is readable by a processor or computer.

The thermal sensor 106 is a device that senses or captures thermal data. The thermal sensor 106 may be integrated into, mounted in, and/or otherwise included in a machine (e.g., printer). In some examples, the thermal sensor 106 may capture thermal images of the build area 102. For instance, the thermal sensor 106 may be an infrared thermal sensor (e.g., camera) that captures thermal images of the build area 102 (e.g., applied material in the build area 102). In some examples, the thermal sensor(s) 106 may provide a 90×90 array of thermal readouts for the top layer (e.g., fusing layer). In some examples, the thermal sensor 106 may capture thermal images during manufacturing (e.g., printing). For example, the thermal sensor 106 may capture thermal images online and/or in real-time. In some examples, the thermal sensor 106 may capture a thermal image of a top layer of build material in a build volume. In some examples, additional sensors may be utilized. For instance, a point sensor or sensors on a wall or walls of the build volume may be utilized to report temperatures at a time for a dimension or dimensions (e.g., x, y, and z). In some examples, a point sensor or sensors on a bottom of the build volume may be utilized to report temperatures at a time for a dimension or dimensions (e.g., x, y, and z).

A thermal image is a set of data indicating temperature (or thermal energy) in an area. A thermal image may be captured (e.g., sensed) from a thermal sensor 106 or may be calculated (e.g., predicted). For example, the thermal sensor 106 may capture a thermal image of a layer to produce a captured thermal image.

In some examples, a captured thermal image may be a two-dimensional (2D) grid of sensed temperatures (or thermal energy). In some examples, each location in the 2D grid may correspond to a location in the build area 102 (e.g., a location (x, y) of a particular level (z) at or above the build area 102). The thermal image or images may indicate thermal variation (e.g., temperature variation) over the build area 102. For example, thermal sensing over the build area 102 may indicate (e.g., capture and encapsulate) environmental complexity and heterogeneous thermal diffusivity. In some approaches, the thermal image or images may be transformed to align with a contone map or contone maps (e.g., registered with the contone map or maps).

In some examples, the controller 116 may receive a captured thermal image of a layer from the thermal sensor 106. For example, the controller 116 may command the thermal sensor 106 to capture a thermal image and/or may receive a captured thermal image from the thermal sensor 106. In some examples, the thermal sensor 106 may capture a thermal image for each layer of an object or objects being manufactured. The captured thermal image is at a resolution. In some examples, the resolution of the captured thermal image is lower than a voxel-level resolution. For example, the resolution of the captured thermal image may be at a low-resolution. Examples of low-resolution include 31×30 pixels, 80×60 pixels, and 90×90 pixels. Each captured thermal image may be stored as thermal image data 129 in the data store 114.

In some examples, the data store 114 may store neural network data 126, thermal image data 129, and/or simulation data 128. The neural network data 126 includes data defining a neural network or neural networks. For instance, the neural network data 126 may define a node or nodes, a connection or connections between nodes, a network layer or network layers, and/or a neural network or neural networks. Examples of neural networks include convolutional neural networks (CNNs) (e.g., basic CNN, deconvolutional neural network, inception module, residual neural network, etc.) and recurrent neural networks (RNNs) (e.g., basic RNN, multi-layer RNN, bi-directional RNN, fused RNN, clockwork RNN, etc.). Some approaches may utilize a variant or variants of RNN (e.g., Long Short Term Memory Unit (LSTM), peephole LSTM, no input gate (NIG), no forget gate (NFG), no output gate (NOG), no input activation function (NIAF), no output activation function (NOAF), no peepholes (NP), coupled input and forget gate (CIFG), full gate recurrence (FGR), gated recurrent unit (GRU), etc.). Different depths of a neural network or neural networks may be utilized.

In some examples, the controller 116 uses the neural network or networks (defined by the neural network data 126) to predict thermal images. For example, the controller 116 may calculate (e.g., predict), using a neural network or a plurality of neural networks, a predicted thermal image of a layer based on a captured thermal image or a plurality of captured thermal images and a contone map or a plurality of contone maps (e.g., a fusing contone map and a detailing contone map). The contone map or maps may be utilized as inputs to the neural network or networks. For instance, a voxel-level contone map or maps may be used in some approaches because the contone map or maps may enable voxel-level energy control and/or may provide information to increase the resolution of the predicted thermal image relative to the resolution of the captured thermal image.

The predicted thermal image is at a resolution. The resolution of the thermal image may be greater than the resolution of the captured thermal image. In some examples, the predicted thermal image is at a voxel-level resolution. An example of voxel-level resolution may be 640×480 pixels. The predicted thermal image or images may be stored in the data store 114 as thermal image data 129. The predicted thermal image or images may be “enhanced” in that the resolution of the predicted thermal image or images may be greater than the resolution of the captured thermal image or images. As used herein, the term “enhance” and variations thereof refer to increasing thermal image resolution using a neural network based on a contone map or maps.

Predicting, calculating, or computing the predicted thermal image may include calculating the predicted thermal image of a layer before, or at a time that the layer is formed. Accordingly, a thermal image for a layer may be “predicted” before or during forming a layer. For example, a thermal image may be predicted for a future layer that has not yet been applied and/or printed. For instance, a machine learning model (e.g., neural network or networks, deep learning, etc.) may be utilized to predict a thermal image. In some approaches, a predicted thermal image of a layer may be computed based on a captured thermal image or images corresponding to a previous layer or layers.

In some examples, the predicted thermal image may correspond to a layer that is subsequent to a layer corresponding to the captured thermal image. For example, the captured thermal image may correspond to a previous layer K−1 and the predicted thermal image may correspond to a layer K. In some examples, a number of captured thermal images of previous layers may also be utilized in the calculation in some examples. The contone map or maps may correspond to the same layer (e.g., layer K) as the layer corresponding to the predicted thermal image and/or to a previous layer or layers.

A contone map may be a representation of agent placement (e.g., placement and/or quantity for a fusing agent and/or placement and/or quantity for a detailing agent). While contone maps are given as examples of data input into the neural network or networks, other information or data may be utilized in addition to or alternatively from contone maps. For example, slices may be utilized to assist predicting thermal images and/or may be utilized as an alternative learning dataset. In particular, slices may be used instead of a contone map or contone maps or in addition to a contone map or contone maps in some examples.

In some examples, other thermal images (e.g., voxel-level captured thermal images) may be utilized to train the neural network or networks in some examples. For instance, the controller 116 may compute a loss function based on the predicted thermal image and the thermal image. The neural network or networks may be trained based on the loss function.

In some examples, a deep neural network architecture may be utilized that takes a sequence of low-resolution thermal images and high-resolution contone maps as input to predict a high-resolution fusing layer thermal image. In some examples, a neural network may include an input layer or layers, an encoder layer or layers, a spatiotemporal layer (e.g., RNN layer), a decoder layer or layers, and/or an output layer or layers. For example, next to the input layer, an encoder layer may extract features from inputs. The spatiotemporal layer may learn both temporal and spatial information from a contone map or maps and a captured thermal image or images (e.g., from real-time in-machine thermal sensing). The decoder layer may translate features into an output domain and may be situated before the output layer. Each layer may include a node or nodes (e.g., more than one node (or perceptron)) in some implementations. In some examples, a neural network may be connected to another neural network or networks, may include another neural network or networks, and/or may be merged (e.g., stacked) with another neural network or networks. In some examples, another neural network or networks may be utilized as an encoder or decoder. In some examples, multiple encoders or decoders may be utilized, or an encoder or decoder may not be implemented or utilized.

In some examples, the controller 116 may upscale the captured thermal image to produce an upscaled thermal image. As used herein, the term “upscaling” and variants thereof denote increasing a resolution of an image. Upscaling may not be based on a contone map and/or may not provide the accuracy of the thermal image enhancement described herein. Examples of upscaling may include interpolation-based approaches, statistical approaches, and/or example-based approaches. For instance, the controller 116 may perform bi-cubic interpolation to upscale the captured thermal image to produce the upscaled thermal image.

In some examples, upscaling the captured thermal image may include performing thermal prediction intensity correction as follows. Thermal prediction intensity correction is an empirical approach for thermal image resolution upscaling. This approach may utilize a simple model to upscale a thermal image of a layer (at 150 pixels per inch (ppi), for example). Examples of the simple thermal predictive model may include first-principle based models or empirical models. This thermal predictive model upscaling may not utilize a neural network and/or may not utilize a contone map or maps. The thermal image may be down-sampled into a same resolution as low-resolution thermal sensing (e.g., 42×30 pixels). Then, a ratio of measured to predicted temperature may be calculated. For example, an un-distorted infrared camera image (at a resolution of 42×30 pixels, for instance) may be utilized to calculate the ratio of measured to predicted temperatures. The camera image may be utilized to adjust the thermal image that was predicted based on the intensity correction derived from the measured infrared camera image. Interpolation may be utilized to up-sample the calculated ratio to the high resolution (e.g., 2496×1872 pixels or 150 ppi). The high-resolution thermal image may be derived by multiplying the high-resolution ratio by the original thermal image that was predicted.

While the thermal image is upscaled, the generated high-resolution image may show gradients due to interpolation. The enhancement result of the intensity correction may not be accurate enough for some applications. However, this approach may provide a high-resolution thermal image, which may be utilized to reduce the difficulties in model-based image enhancement. For example, the thermal prediction intensity correction may be utilized in some examples of thermal image enhancement described herein. Some examples of thermal image enhancement (e.g., modeling approaches) described herein are not limited to thermal prediction intensity correction. Some examples of thermal image enhancement may utilize any thermal sensing resolution upscaling results as model input. The model may learn how to correct the results during model training.

In some examples, the controller 116 may encode, using an encoder (e.g., a first convolutional neural network (CNN)), the upscaled thermal image to produce first data. The first data may include features of the upscaled thermal image. In some examples, the controller 116 may encode, using an encoder (e.g., a second convolutional neural network), the fusing contone map, and/or the detailing contone map to produce second data. The second data may include features of the fusing contone map and/or the detailing contone map. In some examples, the controller 116 may concatenate the first data with the second data to produce concatenated data. The concatenated data may be input to the neural network (e.g., the recurrent neural network (RNN)). In some examples, the controller 116 may decode, using a decoder (e.g., third convolutional neural network), an output of the neural network to produce the predicted thermal image (e.g., the enhanced thermal image).

In some examples, the encoder(s) and/or decoder may be convolutional neural networks. In some examples, the encoder(s) and/or decoder may not be convolutional neural networks. For example, the encoder(s) and/or decoder may be convolutional neural networks combining different components, including convolutional layers, pooling layers, deconvolutional layers, inception layers, and/or residual layers, etc. The specific architecture may be tuned experimentally.

In some examples, the controller 116 performs prediction to produce a set of predicted thermal images using a neural network based on the fusing contone map(s), the detailing contone map(s), and/or a captured thermal image or images. The set of predicted thermal images may be stored (in the data store 114, for example) as thermal image data 129.

The simulation data 128 may include simulation instructions for simulating a layer or layers. For example, the controller 116 may execute the simulation instructions to simulate the thermal behavior (e.g., transient temperature) of a future layer or layers. In some examples, the controller 116 may simulate a layer using a boundary condition that is based on the set of predicted thermal images. In some examples, a predicted thermal image of a layer may be directly applied as a boundary condition for a simulation of the layer.

In some examples, the controller 116 may generate a composite thermal image sequence based on the set of predicted thermal images. A composite thermal image sequence is a sequence of thermal images that represents multiple thermal images corresponding to a composite layer. For example, the controller 116 may assemble the set of thermal images into a single composite thermal image sequence that represents the thermal behavior from multiple layers.

In some examples, the controller 16 may determine the boundary condition based on the composite thermal image sequence. For example, the controller 116 may determine the boundary condition by adjusting the composite thermal image sequence to increase simulation stability. Adjusting the composite thermal image sequence may include applying a low-pass filter to the composite thermal image sequence. The low-pass filter may be applied in both temporal and spatial aspects of the composite thermal image sequence. In some examples, adjusting the composite thermal image sequence may include controlling the composite thermal image sequence with a proportional-integral-derivative (PID) controller.

In some examples, the controller 116 may print a layer or layers based on the predicted thermal image(s) and/or based on the simulation. For instance, the controller 116 may control the amount and/or location of fusing agent 112 and/or detailing agent 120 for a layer based on the predicted thermal image(s) and/or the simulation of the layer(s). In some examples, the controller 116 may drive model setting (e.g., the size of the stride) based on the predicted thermal image(s) and/or simulated layer(s). Additionally or alternatively, the controller 116 may perform offline print mode tuning based on the predicted thermal image(s) and/or the simulated layer(s). For example, if the predicted thermal image and/or the simulation indicates systematic bias (e.g., a particular portion of the build area is consistently colder or warmer than baseline), the data pipeline may be altered such that the contone maps are modified to compensate for such systematic bias. For instance, if the predicted thermal image and/or the simulation indicates a systematic bias, the controller 116 may adjust contone map generation (for a layer or layers, for example) to compensate for the bias. Accordingly, the location and/or amount of agent(s) deposited may be adjusted based on the contone map(s) to improve print accuracy and/or performance.

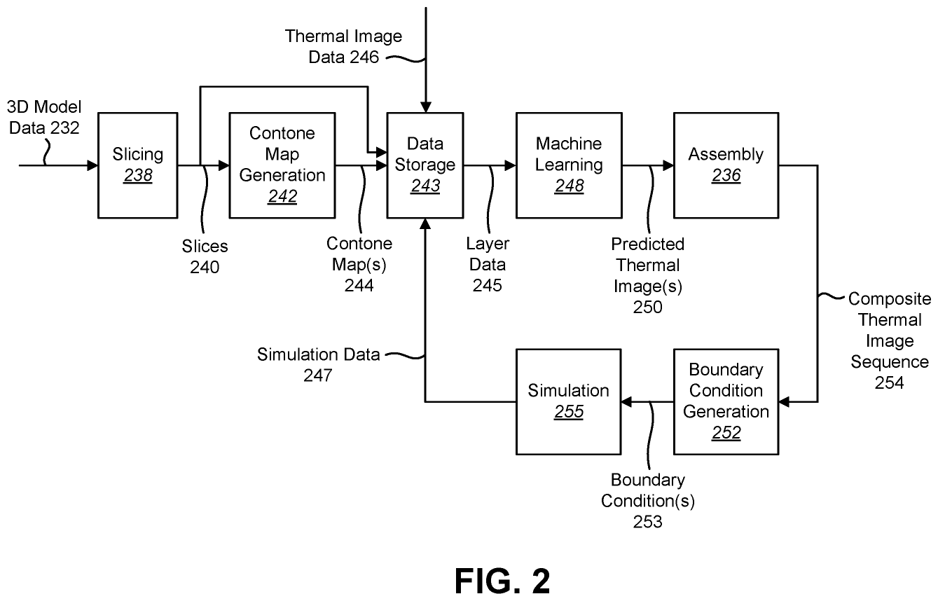

FIG. 2 is a block diagram illustrating examples of functions that may be implemented for adapting manufacturing simulation. In some examples, one, some, or all of the functions described in connection with FIG. 2 may be performed by the controller 116 described in connection with FIG. 1. For instance, instructions for slicing 238, contone map generation 242, machine learning 248, data storage 243, assembly 236, boundary condition generation 252, and/or simulation 255 may be stored in the data store 114 and executed by the controller 116 in some examples. In other examples, a function or functions (e.g., slicing 238, contone map generation 242, machine learning 248, data storage 243, assembly 236, boundary condition generation 252, and/or simulation 255) may be performed by another apparatus. For instance, slicing 238 may be carried out on a separate apparatus and sent to the 3D printing device 100.

3D model data 232 may be obtained. For example, the 3D model data 232 may be received from another device and/or generated. The 3D model data 232 may specify shape and/or size of a 3D model for printing a 3D object or objects. 3D model data 232 can define both the internal and the external portion of the 3D object. The 3D model data 232 can be defined, for example, using polygon meshes. For example, the 3D model data 232 can be defined using a number of formats such as a 3D manufacturing format (3MF) file format, an object (OBJ) file format, and/or a stereolithography (STL) file format, among other type of files formats. In some examples, the 3D model data may be referred to as a “batch.”

Slicing 238 may be performed based on the 3D model data 232. For example, slicing 238 may include generating a set of 2D slices 240 corresponding to the 3D model data 232. In some approaches, the 3D model indicated by the 3D model data 232 may be traversed along an axis (e.g., a vertical axis, z-axis, or other axis), where each slice 240 represents a 2D cross section of the 3D model. For example, slicing 238 the 3D model can include identifying a z-coordinate of a slice plane. The z-coordinate of the slice plane can be used to traverse the 3D model to identify a portion or portions of the 3D model intercepted by the slice plane.

A 3D model and/or stack of 2D slices (e.g., vector slices) may be utilized to generate per-layer machine instructions (e.g., voxel-level agent distribution) by accounting for process physics. Contone maps may be examples of per-layer machine instructions. In some examples, contone map generation 242 may be performed based on the slices 240. For example, a contone map or contone maps 244 may be generated for each slice 240. For instance, contone map generation 242 may include generating a fusing contone map and a detailing contone map, where the fusing contone map indicates an area or areas and density distribution for printing fusing agent for a layer. The detailing contone map indicates an area or areas and density distribution for printing detailing agent for the layer. The contone map or maps 244 may be represented in a variety of file formats in some examples. For instance, a contone map 244 may be formatted as an image file and/or another kind of contone file. In some examples, a function or functions described in connection with FIG. 2 may be performed by a printer. For example, 3D model data 232 may be loaded onto a printer, which may perform a function or functions described in connection with FIG. 2. In some examples, slicing 238 and/or contone map generation 242 may include using firmware to voxelize and/or rasterize the 3D model data 232 (e.g., geometry) and generating agent dispensing maps (e.g., fusing agent and/or detailing agent contone map(s) 244) for a build.

The contone map(s) 244, slices 240, and/or thermal image data 246 (e.g., captured thermal image(s)) may be stored using a data storage 243 function. For example, the contone map(s) 244, slices 240, and/or thermal image data 246 may be stored (in a database, for instance) in a storage device. In some examples, thermal images (e.g., videos, one video per layer) may be stored. In some examples, the thermal images may be continuously generated during printing up to a most recent layer (e.g., K−1) before the current layer. The current layer may be denoted with the variable K. For instance, when printing starts, a thermal sensor or sensors may write a sequence of images (e.g., video(s)) to memory that indicate a temperature distribution over a fusing surface. In some examples, when printing layer K, thermal sensing data up to layer (K−1) may be accessible.

In some examples, other data (e.g., a 3MF file) may be additionally or alternatively stored. Layer data 245 may be provided to machine learning 248. Layer data 245 may include data (e.g., slice(s), contone map(s), thermal image(s), etc.) corresponding to previous layers. For example, while the printer is printing layer K, layer data 245 for layers K-a to K−1 may be loaded into machine learning 248. In this context, “a” refers to an integer number (e.g., 30) in “K-a.”

The machine learning 248 may be used to calculate (e.g., predict) a predicted thermal image or images 250 based on the layer data 245. The predicted thermal image(s) 250 may correspond to layer K and/or an additional layer or layers. In some examples, the machine learning 248 (e.g., neural network, deep learning inference) may utilize the thermal images corresponding to layers from (K−1-a) to (K−1) to predict forward b layers, where b≥1. For instance, the machine learning 248 may predict thermal images for layer K, K+1, . . . , K+b−1, for when each of the layers is exposed as a fusing layer. For each layer, the predicted thermal images 250 may be a sequence of images that represent the transient thermal behavior at the fusing boundary in some examples.

In some examples, the machine learning 248, when online, may utilize low-resolution in-situ thermal image(s) (with dimension of 30×31 or 90×90 pixels, for instance), and the high-resolution contone maps to predict a high-resolution fusing layer thermal image (with dimensions of 640*480, for instance). The machine learning 248 may learn to infer subsequent layer thermal behavior and high-resolution fine details (along a surface boundary, for example) from thermal image spatiotemporal information, fine details in contone maps, and/or information added in a correction procedure. The machine learning 248 may provide improved fidelity (with significant improvement in the aspect of boundary details, for example), in comparison with some kinds of simulation. The machine learning 248 may partially or fully capture printer operation variations (e.g., variations due to environmental factors, printer drifts, printer variation and/or printer functioning) to represent current (e.g., up-to-the-moment) reality. Information representing the printer operation variation(s) captured by the machine learning 248 may be applied to the simulation 255. In some examples, adapting the simulation 255 may include setting a boundary condition based on a predicted thermal image or images 250.

In some examples, an assembly 236 function may be performed on the predicted thermal images 250 to produce a composite thermal image sequence 254. For example, assembly 236 may include grouping multiple predicted thermal images 250 (corresponding to multiple print layers, for instance) into one composite thermal image sequence 254 corresponding to a composite layer to reduce simulation time. The composite layer may include b print layers, where b is an integer and b≥1. For example, the machine learning 248 may produce predicted thermal images 250 for layers K+1, . . . , K+b. In a case where b>1, assembly 236 may include assembling the transient predicted thermal images 250 for layer K, K+1, . . . , K+b−1 sequentially into a single composite thermal image sequence 254 that represents the transient fusing boundary condition of the composite (e.g., artificial) layer. For instance, a predicted thermal image 250 for a first layer may be assembled with a second predicted thermal image 250 for a second layer to produce the composite thermal image sequence 254. In other examples (e.g., in a case where b==1), a composite layer and/or a composite thermal image sequence 254 may not be produced and/or assembly 236 may not be performed. In some examples, adapting the simulation 255 may include setting a boundary condition 253 based on the composite thermal image sequence 254.

Boundary condition generation 252 may include generating a boundary condition or conditions 253 (e.g., top surface boundary condition) for the simulation 255. In some examples, the composite thermal image sequence 254 may be applied as a boundary condition 253 to the simulation 255 of a build volume (corresponding to layers 0 to K+b−1, for instance). For example, the output of the assembly 236 function may be directly applied to the simulation 255 as a fixed boundary condition 253 (for a top fusing boundary, for instance). For example, in simulation 255, the top surface of each voxel in the fusing layer may have a transient temperature generated by the assembly 236 function. In some examples, the simulation 255 may include simulating a build volume for the composite layer and/or for a duration that consumes the composite thermal image sequence 254 from the assembly 236, such that a total exposed time is met for both cases where b=1 and b>1.

In case that assembly 236 produces a composite thermal image sequence 254 with high frequency variation in space and/or time, directly applying the composite thermal image sequence 254 (e.g., temperature) as boundary condition(s) may not be numerically stable or sound. An example of high frequency variation in space may include small features (e.g., lattice features) that change from pixel to pixel, where spatially the build changes frequently from object to powder and thus temperature fluctuates frequently. An example of high frequency variation in time may include a sudden temperature rise or drop for the same neighborhood of pixels (e.g., application of detailing agent).

In some examples, the boundary condition generation 252 function may include an operation or operations to increase stability and/or to avoid potential instability. For example, boundary condition generation 252 may include applying a low-pass filter in time and/or space (e.g., a temporal and/or spatial low-pass filter) to a predicted thermal image 250 (in a case where b==1, for instance) and/or to the composite thermal image sequence 254 (in a case where b>1, for instance) to produce a filtered thermal image. Applying the low-pass filter may reduce high frequency variation in the predicted thermal image 250 and/or in the composite thermal image sequence 254, which may help to avoid simulation 255 instability. In some examples, adapting the simulation 255 may include setting a boundary condition 253 based on the filtered thermal image.

In some examples, boundary condition generation 252 may include controlling a predicted thermal image 250 and/or a composite thermal image sequence 254 to produce a controlled thermal image. In some examples, adapting the simulation may include setting a boundary condition 253 based on the controlled thermal image. For example, a controller (e.g., a PID controller) may be utilized to control the predicted thermal image 250 and/or the composite thermal image sequence 254. For instance, a PID controller may be utilized in accordance with Equation (1).

T=Tₛₑₙₛₒᵣ(t)+p*(T−Tₛₑₙₛₒᵣ(t))+i*Int(T−Tₛₑₙₛₒᵣ(t))+d*d(T−Tₛₑₙₛₒᵣ(t))/dt (1)

In Equation (1), T is a boundary condition 253 (e.g., temperature), Tₛₑₙₛₒᵣ(t) is a temperature (e.g., predicted thermal image 250 or composite thermal image sequence) for time t, Int denotes an integral, d/dt denotes a derivative, and p, i, and d are tunable factors (e.g., constants, weights) that may help the simulation 255 to better absorb the shock caused by the gradient of Tₛₑₙₛₒᵣ(t) in both time and space (thus increasing the numerical stability, for example). In some examples, applying the low-pass filter or applying the controller (e.g., PID controller) may be alternatives to directly applying the predicted thermal image(s) 250 and/or the composite thermal image sequence 254 (e.g., Tₛₑₙₛₒᵣ(t) curve) to the voxel top surface as fixed temperature boundary condition.

The simulation 255 may be a transient simulation of a layer-by-layer additive procedure (e.g., a simulation of additive manufacturing). In some examples, when simulating one composite (e.g., artificial) layer, the temperature boundary condition 253 obtained from boundary condition generation 252 may be applied to drive further thermal diffusion through the buried layers. In some examples, the simulation 255 produces a simulated composite layer based on a composite thermal image sequence 254 that is based on the predicted thermal image 250 of a first layer and a second predicted thermal image 250 of a second layer.

The simulation 255 produces simulation data 247, which may be provided to data storage 243. In some examples, simulation data 247 includes temperatures (e.g., refreshed temperatures for a build volume up to layer K+b). For example, upon completing the simulation 255 of one composite layer, the transient history for each thermal voxel may be recorded into a database. For instance, a simulated layer that is based on an adapted simulation 255 may be stored in memory. In some examples, storing the simulation data 247 (e.g., recording the transient history for a composite layer) may trigger pushing a subsequent set of layer data 245 (e.g., new thermal imaging data) to machine learning 248. The function(s) (e.g., machine learning 248, assembly 236, boundary condition generation 252, and/or simulation 255) may be repeated.

In some examples, an operation or operations may be performed based on the simulation data 247. For example, control information may be determined based on the simulation data 247. The control information may be utilized to print a layer or layers based on the simulation data 247. For instance, the control information may indicate controlling the amount and/or location of fusing agent and/or detailing agent for a layer based on the simulation data 247. In some examples, the control information may drive model setting (e.g., the size of the stride) based on the simulation data 247 (e.g., thermal diffusion). Additionally or alternatively, the control information may indicate offline print mode tuning based on the simulation data 247. For example, if the predicted simulation data 247 indicates systematic bias (e.g., a particular portion of the build area is consistently colder or warmer than baseline), the data pipeline may be altered such that the contone maps are modified to compensate for such systematic bias. For instance, if the simulation data 247 indicates a systematic bias, the control information may indicate an adjustment to contone map generation (for a layer or layers, for example) to compensate for the bias. Accordingly, the location and/or amount of agent(s) deposited may be adjusted based on the contone map(s) to improve print accuracy and/or performance. In some examples, performing an operation may include presenting the simulation data 247 on a display and/or sending the simulation data 247 to another device.

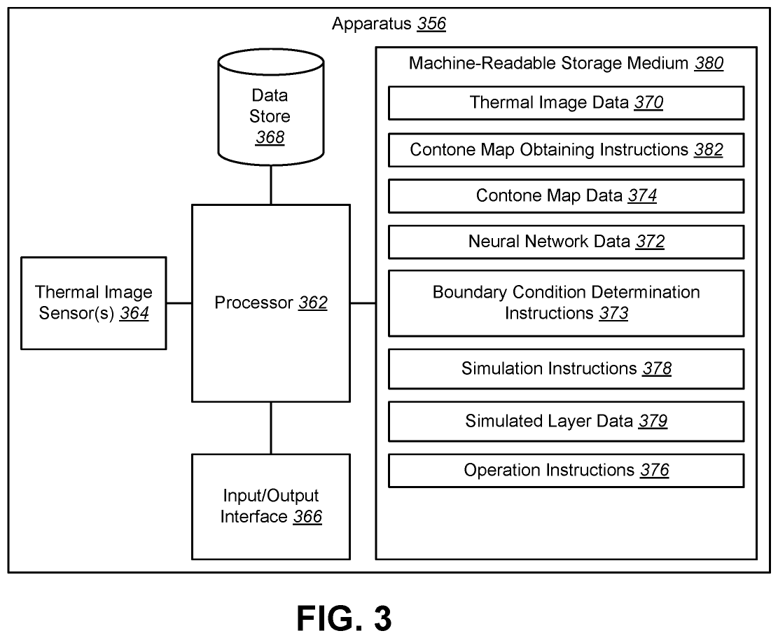

FIG. 3 is a block diagram of an example of an apparatus 356 that may be used in adapting manufacturing simulation. The apparatus 356 may be a computing device, such as a personal computer, a server computer, a printer, a 3D printer, a smartphone, a tablet computer, etc. The apparatus 356 may include and/or may be coupled to a processor 362, a data store 368, an input/output interface 366, a machine-readable storage medium 380, and/or a thermal image sensor or sensors 364. In some examples, the apparatus 356 may be in communication with (e.g., coupled to, have a communication link with) an additive manufacturing device (e.g., the 3D printing device 100 described in connection with FIG. 1). Alternatively, the apparatus 356 may be an example of the 3D printing device 100 described in connection with FIG. 1. For instance, the processor 362 may be an example of the controller 116 described in connection with FIG. 1, the data store 368 may be an example of the data store 114 described in connection with FIG. 1, and the thermal image sensor or sensors 364 may be an example of the thermal sensor 106 described in connection with FIG. 1. The apparatus 356 may include additional components (not shown) and/or some of the components described herein may be removed and/or modified without departing from the scope of this disclosure.

The processor 362 may be any of a central processing unit (CPU), a semiconductor-based microprocessor, graphics processing unit (GPU), FPGA, an application-specific integrated circuit (ASIC), and/or other hardware device suitable for retrieval and execution of instructions stored in the machine-readable storage medium 380. The processor 362 may fetch, decode, and/or execute instructions (e.g., operation instructions 376) stored on the machine-readable storage medium 380. Additionally or alternatively, the processor 362 may include an electronic circuit or circuits that include electronic components for performing a functionality or functionalities of the instructions (e.g., operation instructions 376). In some examples, the processor 362 may be configured to perform one, some, or all of the functions, operations, aspects, methods, etc., described in connection with one, some, or all of FIGS. 1-5.

The machine-readable storage medium 380 may be any electronic, magnetic, optical, or other physical storage device that contains or stores electronic information (e.g., instructions and/or data). Thus, the machine-readable storage medium 380 may be, for example, Random Access Memory (RAM), Electrically Erasable Programmable Read-Only Memory (EEPROM), a storage device, an optical disc, and the like. In some implementations, the machine-readable storage medium 380 may be a non-transitory tangible machine-readable storage medium, where the term “non-transitory” does not encompass transitory propagating signals. While that machine-readable storage medium 380 is shown as being included in the apparatus 356, a machine-readable storage medium 380 may be implemented independently (e.g., separate from an apparatus 356).

The apparatus 356 may also include a data store 368 on which the processor 362 may store information. The data store 368 may be volatile and/or non-volatile memory, such as Dynamic Random Access Memory (DRAM), EEPROM, magnetoresistive random-access memory (MRAM), phase change RAM (PCRAM), memristor, flash memory, and the like. In some examples, the machine-readable storage medium 380 may be included in the data store 368. Alternatively, the machine-readable storage medium 380 may be separate from the data store 368. In some approaches, the data store 368 may store similar instructions and/or data as that stored by the machine-readable storage medium 380. For example, the data store 368 may be non-volatile memory and the machine-readable storage medium 380 may be volatile memory.

The apparatus 356 may further include an input/output interface 366 through which the processor 362 may communicate with an external device or devices (not shown), for instance, to receive and store the information pertaining to the object or objects to be manufactured (e.g., printed). The input/output interface 366 may include hardware and/or machine-readable instructions to enable the processor 362 to communicate with the external device or devices. The input/output interface 366 may enable a wired or wireless connection to the external device or devices. The input/output interface 366 may further include a network interface card and/or may also include hardware and/or machine-readable instructions to enable the processor 362 to communicate with various input and/or output devices, such as a keyboard, a mouse, a display, another apparatus, electronic device, computing device, etc., through which a user may input instructions into the apparatus 356.

In some examples, the machine-readable storage medium 380 may store thermal image data 370. The thermal image data 370 may be obtained (e.g., received) from a thermal image sensor or sensors 364 and/or may be predicted. For example, the processor 362 may execute instructions (not shown in FIG. 3) to obtain a captured thermal image or images for a layer or layers. In some examples, the apparatus 356 may include a thermal image sensor or sensors 364, may be coupled to a remote thermal image sensor or sensors, and/or may receive thermal image data 370 (e.g., a thermal image or images) from a (integrated and/or remote) thermal image sensor. Some examples of thermal image sensors 364 include thermal cameras (e.g., infrared cameras). Other kinds of thermal sensors may be utilized. In some examples, thermal sensor resolution may be less than voxel resolution (e.g., each temperature readout may cover an area that includes multiple voxels). For example, a low-resolution thermal camera with a low-resolution (e.g., 31×30 pixels, 80×60 pixels, 90×90 pixels, etc.) may be utilized. In other examples, a high-resolution thermal image sensor or sensors 364 may provide voxel-level (or near voxel-level) thermal sensing (e.g., 640×480 pixels) for neural network training.

The thermal image data 370 may include a thermal image or images. As described above, a thermal image may be an image that indicates heat (e.g., temperature) over an area and/or volume. For example, a thermal image may indicate a build area temperature distribution (e.g., thermal temperature distribution over a top layer). In some examples, the thermal image sensor or sensors 364 may undergo a calibration procedure to overcome distortion introduced by the thermal image sensor or sensors 364. For example, a thermal image may be transformed to register the thermal image with the contone map or maps. Different types of thermal sensing devices may be used in different examples.

In some examples, the contone map obtaining instructions 382 may be code to cause the processor 362 to obtain a fusing contone map and/or a detailing contone map. For instance, the processor 362 may execute contone map obtaining instructions 382 to obtain contone map data 374. For example, the contone map obtaining instructions 382 may generate a contone map or maps (e.g., from slice data and/or 3D model data) and/or may receive a contone map or maps from another device (via the input/output interface 366, for example). The contone map data 374 may indicate agent distribution (e.g., fusing agent distribution and/or detailing agent distribution) at the voxel level for printing a 3D object. For instance, the contone map data 374 may be utilized as per-layer machine instructions (e.g., voxel-level machine instructions) for agent distribution.

In some examples, multiple different agent contone maps corresponding to different abilities to absorb or remove thermal energies may be utilized. Additionally or alternatively, some examples may utilize different print modes where multiple contone maps may be used for each agent.

For a given layer (e.g., a current layer, a top layer, etc.), the contone map or maps of all agents deposited to the layer may be an energy driving force in some examples. In some examples, another voxel-level energy influencer may include neighboring voxels in previous layers that may have a temperature differential compared to a given voxel, which may induce heat flux into or out of the voxel.

The machine-readable storage medium 380 may store neural network data 372. The neural network data 372 may include data defining and/or implementing a neural network or neural networks. For instance, the neural network data 372 may define a node or nodes, a connection or connections between nodes, a network layer or network layers, and/or a neural network or neural networks. In some examples, the processor 362 may utilize (e.g., execute instructions included in) the neural network data 372 to calculate predicted thermal images. A predicted thermal image or images may be stored as thermal image data 370 on the machine-readable storage medium 380.

In some examples, the processor 362 uses the neural network or networks (defined by the neural network data 372) to enhance the captured thermal image or images. For example, the processor 362 may enhance the captured thermal image using a neural network or networks based on the contone map or maps to produce an enhanced thermal image or images. The enhanced thermal image(s) may have an increased resolution relative to a resolution of the captured thermal image(s). The enhanced thermal image or images may be stored as thermal image data 370. For instance, the processor 362 may calculate (e.g., predict), using a neural network or a plurality of neural networks, a predicted thermal image of a layer based on a captured thermal image or a plurality of captured thermal images and a contone map or a plurality of contone maps (e.g., a fusing contone map and a detailing contone map).

In some examples, the neural network data 372 may be code to cause the processor 362 to predict a thermal image corresponding a subsequent layer (e.g., a layer K, K+1, etc., that is after a layer K−1). In some examples, predicting a thermal image (e.g., predicting, calculating, or computing the predicted thermal image) may include calculating the enhanced thermal image of the layer before or at a time that the layer is formed. In some examples, the predicted thermal image may correspond to a layer that is subsequent to a layer corresponding to the captured thermal image. In some examples, a number of captured thermal images of previous layers may also be utilized in the calculation in some examples. The contone map or maps may correspond to the same layer (e.g., layer K) as the layer corresponding to the enhanced thermal image and/or to a previous layer or layers.

In some examples, the machine-readable storage medium 380 may include boundary condition determination instructions 373. The boundary condition determination instructions 373 are code to cause the processor 362 to determine a boundary condition based on the predicted thermal image(s). For example, the boundary condition determination instructions 373 may include code to assemble predicted thermal images and/or code to generate a boundary condition (e.g., apply a low-pass filter to a composite thermal image sequence and/or to control the composite thermal image sequence, and/or set a boundary condition based on the predicted thermal image(s) and/or the composite thermal image sequence) as described in connection with FIG. 1 and/or FIG. 2.

In some examples, the machine-readable storage medium 380 may include simulation instructions 378. The simulation instructions 378 are code to cause the processor 362 to simulate manufacturing of a layer or layers (e.g., subsequent layer(s)) based on the boundary condition. For example, the simulation instructions 378 may include code to simulate, layer-by-layer, a manufacturing procedure adaptively based on the boundary condition. In some examples, simulation may be carried out as described in connection with FIG. 1 and/or FIG. 2. Performing the simulation may produce simulated layer data 379, which may be stored in the machine-readable storage medium 380. The simulated layer data 379 may include information indicating transient thermal behavior of a voxel or voxels based on the adapted simulation. In some examples, using the neural network to predict the thermal image enables the simulation to account for a variation or variations in printer operation.

In some examples, the processor 362 may execute operation instructions 376 to perform an operation based on the simulated layer data 379. For example, the processor 362 may print (e.g., control amount and/or location of agent(s) for) a layer or layers based on the simulated layer data 379. In some examples, the processor 362 may drive model setting (e.g., the size of the stride) based on the simulated layer data 379. Additionally or alternatively, the processor 362 may perform offline print mode tuning based on the simulated layer data 379. Additionally or alternatively, the processor 362 may send a message (e.g., alert, alarm, progress report, quality rating, etc.) based on the simulated layer data 379. Additionally or alternatively, the processor 362 may halt printing in a case that the simulated layer data 379 indicates a problem (e.g., more than a threshold difference between a simulated layer or layers of printing and the 3D model and/or slices). Additionally or alternatively, the processor 362 may feed the simulated layer data 379 for the upcoming layer to a thermal feedback control system to online compensate the contone maps for the upcoming layer. In some examples, the operation instructions 376 may include instructions to present the simulated layer data 379. For example, the instructions may cause the processor 362 to render and/or present the simulated layer data 379 on a display. For example, the simulated layer data 379 may be presented as a 3D graph that indicates temperature spatially over a build volume and/or that indicates temperature at a time or times.

In some examples, the machine-readable storage medium 380 may store 3D model data (not shown in FIG. 3). The 3D model data may be generated by the apparatus 356 and/or received from another device. In some examples, the machine-readable storage medium 380 may include slicing instructions (not shown in FIG. 3). For example, the processor 362 may execute the slicing instructions to perform slicing on the 3D model data to produce a stack of 2D vector slices.

In some examples, the operation instructions 376 may include 3D printing instructions. For instance, the processor 362 may execute the 3D printing instructions to print a 3D object or objects. In some implementations, the 3D printing instructions may include instructions for controlling a device or devices (e.g., rollers, print heads, and/or thermal projectors, etc.). For example, the 3D printing instructions may use a contone map or contone maps (stored as contone map data, for instance) to control a print head or heads to print an agent or agents in a location or locations specified by the contone map or maps. In some examples, the processor 362 may execute the 3D printing instructions to print a layer or layers. The printing (e.g., thermal projector control) may be based on thermal images (e.g., captured thermal images, predicted thermal images, and/or simulated layer(s)).

In some examples, the machine-readable storage medium 380 may store neural network training instructions. The processor 362 may execute the neural network training instructions to train a neural network or neural networks (defined by the neural network data 372, for instance). In some examples, the processor 362 may train the neural network or networks using a set of training thermal images. In some examples, a function or functions described in connection with FIG. 3 may be omitted and/or not performed.

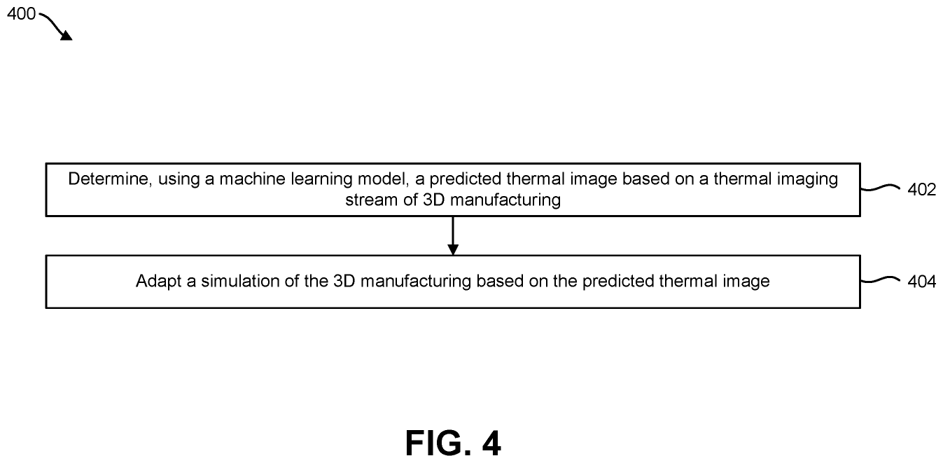

FIG. 4 is a flow diagram illustrating an example of a method 400 for adapting manufacturing simulation. The method 400 and/or a method 400 step or steps may be performed by an electronic device. For example, the method 400 may be performed by the apparatus 356 described in connection with FIG. 3 (and/or by the 3D printing device 100 described in connection with FIG. 1).

The apparatus 356 may determine 402, using a machine learning model, a predicted thermal image based on a thermal imaging stream of 3D manufacturing. This may be accomplished as described in connection with FIGS. 1, 2, and/or 3. A thermal imaging stream is a sequence of thermal images (e.g., video) captured by a thermal sensor. In some examples, the thermal imaging stream may be continuously captured during printing. The apparatus 356 may utilize a thermal image or images from the thermal imaging stream to determine the predicted thermal image. For example, the apparatus 356 may utilize a trained machine learning model (e.g., neural network(s)) to determine the predicted thermal image.

The apparatus 356 may adapt 404 a simulation of the 3D manufacturing based on the predicted thermal image(s). This may be accomplished as described in connection with FIGS. 1, 2, and/or 3. For example, adapting the simulation may include setting a boundary condition based on the predicted thermal image(s). For example, the apparatus 356 may directly set a boundary condition of the simulation with the predicted thermal image(s) directly, with a composite thermal image sequence directly, with a filtered thermal image, and/or with a controlled thermal image. In some examples, the method 400 may include a function or functions described in connection with FIGS. 1, 2, and/or 3.

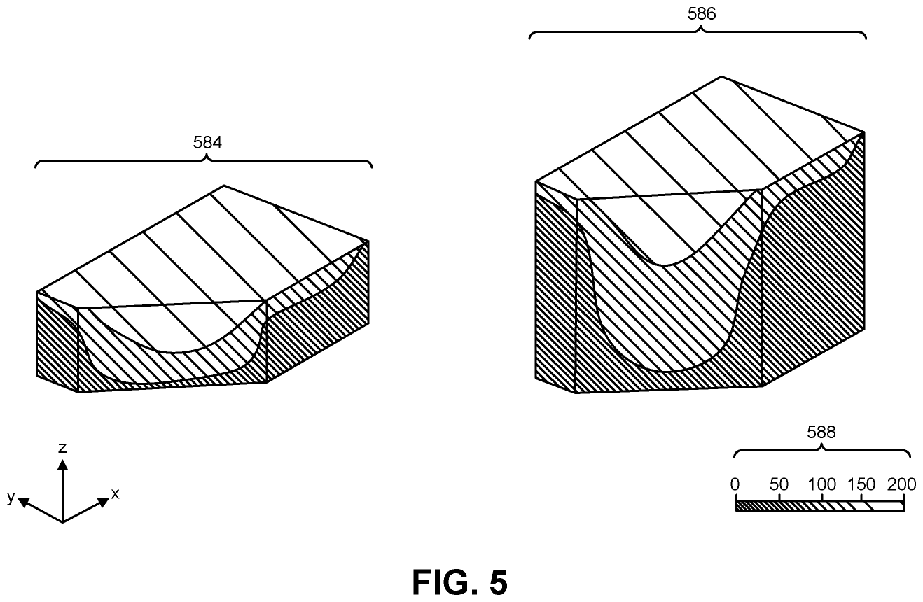

FIG. 5 is a simplified perspective view of an example of visualizations 584, 586 of simulation results in accordance with some examples of the techniques described herein. Some examples of the simulation described herein include a simulation of a transient manufacturing (e.g., printing) procedure. The simulation may produce a transient temperature history for each voxel as simulation results. The visualizations 584, 586 are simplified temperature maps corresponding to a build volume at different times. For example, the first visualization 584 illustrates simulation results of 3D manufacturing at a first time, and the second visualization 586 illustrates simulation results of the 3D manufacturing at a second later time. Both of the visualizations 584, 586 include cutaways to illustrate internal temperatures (e.g., buried layers). In this example, the temperatures are illustrated on a simplified scale in degrees Fahrenheit 588. Other examples may be presented on a color gradient scale to show finer temperature variation than the example in FIG. 5.

In some examples, visualizations of simulation results may be presented on a display and/or simulation results may be sent to another device (e.g., computing device, monitor, etc.) to present visualizations of simulation results. In the example illustrated in FIG. 5, the simulation reflects manufacturing where objects are built up layer by layer.

Some examples of the techniques described herein may provide simulation that accounts for current (e.g., up-to-the-moment) ground truth and that can continuously learn and adapt to situational change. Adapting the simulation may enable simulation to be utilized beyond offline prediction, e.g., to predict a batch's yield before it is printed. In some examples, adapting simulation may allow the simulation to be applied for operational applications since the quantitative results may be accurate and up to the moment. For example, a printer operating system may be utilized to generate thermal image predictions and/or simulation that can be utilized for correction.

While various examples of systems and methods are described herein, the systems and methods are not limited to the examples. Variations of the examples described herein may be implemented within the scope of the disclosure. For example, operations, functions, aspects, or elements of the examples described herein may be omitted or combined.

1. A method, comprising:
determining, using a machine learning model, a predicted thermal image based on a thermal imaging stream of three-dimensional (3D) manufacturing; and
adapting a simulation of the 3D manufacturing based on the predicted thermal image.

2. The method of claim 1, wherein adapting the simulation comprises setting a boundary condition based on the predicted thermal image.

3. The method of claim 1, further comprising assembling the predicted thermal image for a first layer with a second predicted thermal image for a second layer to produce a composite thermal image sequence.

4. The method of claim 3, wherein adapting the simulation comprises setting a boundary condition based on the composite thermal image sequence.

5. The method of claim 1, further comprising applying a low-pass filter in time and space to the predicted thermal image or a composite thermal image sequence to produce a filtered thermal image.

6. The method of claim 5, wherein adapting the simulation comprises setting a boundary condition based on the filtered thermal image.

7. The method of claim 1, further comprising controlling the predicted thermal image or a composite thermal image sequence to produce a controlled thermal image.

8. The method of claim 7, wherein adapting the simulation comprises setting a boundary condition based on the controlled thermal image.

9. The method of claim 1, wherein the simulation produces a simulated composite layer based on a composite thermal image sequence that is based on the predicted thermal image of a first layer and a second predicted thermal image of a second layer.

10. The method of claim 1, further comprising storing, in memory, a simulated layer based on the adapted simulation.

11. A three-dimensional (3D) printing device, comprising:
a print head to print a fusing agent based on a fusing contone map;
a thermal projector;
a thermal sensor; and
a controller, wherein the controller is to:
predict, using a neural network based on the fusing contone map and a captured thermal image, a set of predicted thermal images; and
simulate a layer using a boundary condition that is based on the set of predicted thermal images.

12. The 3D printing device of claim 11, wherein the controller is to:
generate a composite thermal image sequence based on the set of predicted thermal images; and
determine the boundary condition based on the composite thermal image sequence.

13. The 3D printing device of claim 12, wherein the controller is to determine the boundary condition by adjusting the composite thermal image sequence to increase simulation stability.

14. A non-transitory tangible computer-readable medium storing executable code, comprising:
code to cause a processor to obtain a fusing contone map and a captured thermal image corresponding to a layer;
code to cause the processor to predict a thermal image corresponding to a subsequent layer that is after the layer using a neural network;
code to cause the processor to determine a boundary condition based on the predicted thermal image; and
code to cause the processor to simulate manufacturing of the subsequent layer based on the boundary condition.

15. The computer-readable medium of claim 14, wherein using the neural network to predict the thermal image enables simulation to account for a variation in printer operation.
